(19) United States
(12) Patent Application Publication
(10) Pub. No.: US 2016/0097517 A1
(43) Pub. Date: Apr. 7, 2016

(54) PENDANT LUMINAIRE

(71) Applicant: REVAMP LIGHTING LLC, New Richmond, WI (US)

(72) Inventors: Todd D. LOEHR, Lake Elmo, WI (US); Lee D. STAGNI, Golden Valley, MN (US); Ahmad KIAN, Minneapolis, MN (US); Ehssan TAGHIZADEH, Minneapolis, MN (US)

(73) Assignee: REVAMP LIGHTING LLC, New Richmond, WI (US)

(21) Appl. No.: 14/876,587

(22) Filed: Oct. 6, 2015

Related U.S. Application Data
(60) Provisional application No. 62/060,376, filed on Oct. 6, 2014.

(51) Int. Cl. F21V 21/104; F21V 29/70; F21V 1/08

(52) U.S. Cl. CPC F21V 21/104; F21V 1/08; F21V 29/70; F21Y 2105/001

(57) ABSTRACT

This disclosure provides a lighting device that includes an outer frame, an inner frame, and a planar light emitter. The outer frame includes a top member, a bottom member, and one or more vertical members connected between the top member and the bottom member. The inner frame has a geometry smaller than the outer frame, wherein the inner frame is located within the outer frame and connected to the outer frame via one or more connecting arms, wherein the length of the connecting arms determines the vertical position of the inner frame within the outer frame. The planar light emitter is mounted to the inner frame, which includes a plurality of light-emitting diodes (LEDs), wherein the plurality of LEDs are located in a two-dimensional plane that is approximately parallel with the top member and the bottom member.

### CROSS REFERENCE TO RELATED APPLICATION

This application claims the benefit of U.S. Provisional Application No. 62/060,376 filed on 6 Oct. 2014, and which application is incorporated herein by reference. A claim of priority is made.

### BACKGROUND

A pendant luminaire (aka suspended luminaire) consists of a light source covered by a lampshade that is attached to the ceiling or truss in a space to provide decorative or space lighting. Space lighting may be ambient lighting, directional (task) lighting, or some combination thereof. The primary factors that determine the lighting potential of a pendant luminaire are the light source, the shade, and the diffuser.

Traditionally, pendant luminaires are illuminated using incandescent or fluorescent bulbs and more recently light emitting diode bulbs. In each case, these bulbs are engineered to emit omnidirectional light, directing light in a full 360 degrees around the bulb. When installed in a pendant luminaire, either horizontally or vertically, uneven light emission can create bright (hot) or dark spots behind the shade. Hot and dark spots detract from the aesthetics of the luminaire which is an important consideration of interior design. To compensate, traditional pendant luminaire designers utilize the shape of the shade and its interior reflective properties to minimize these undesirable hot/dark spots or to increase the effectiveness of the luminaire for directional (task) lighting applications.

The lampshade also determines the lighting potential for pendant luminaires. Lampshades with a geometric shape that provides a smaller geometric opening at the top and angled sidewalls tend to be better at reflecting omnidirectional light downward for task lighting. Lampshades with a similarly sized opening at the top and bottom, commonly found in today's popular drum or box shades, fail to achieve maximum downward light reflection. The material used to construct the shade will also have a significant impact on its reflectivity.

Conventional lampshades can be transparent, semitransparent and nontransparent (opaque), and can be dependent on the material used to manufacture the shade. Lampshades produced from the glass will obtain a full transparency, allowing virtually all of the light emitted from the bulb to pass, but are fragile and lack the reflective properties necessary to re-direct omnidirectional light downward through the bottom of the shade for task lighting applications.

Shades made from metal are nontransparent and allow no light to pass, minimizing the ambient lighting potential of the pendant luminaire. Metal shades do, however, offer good internal reflectivity which redirects the omnidirectional light downward through the bottom of the shade for task lighting.

Among the most desirable lampshades are those constructed using fabric wrapped around a wire frame structure. Interior designers prefer these luminaires because of their aesthetic value and their ability to be reconfigured by replacing the lampshade. Yet these luminaires are less favored by lighting designers who are challenged to optimize their space lighting strategy and typically deploy a pendant luminaire for task lighting applications.

Pendant luminaires with fabric lampshades generally offer ambient lighting because the shade is semitransparent and the light source is omnidirectional. While these features favor the deployment of these luminaires for ambient lighting, they fall short as task lighting resources.

Acrylic diffuser panels are often incorporated into the top and/or bottom of the shade. These panels prevent direct viewing of the light source from beneath the ceiling-mounted pendant or from above low-hanging pendants. In addition to shielding the light source from view, diffusers can serve to help spread uneven light generated from within the pendant.

### SUMMARY

According to an exemplary embodiment, a lighting device includes an outer frame, an inner frame, and a planar light emitter. The outer frame includes a top member, a bottom member, and one or more vertical members connected between the top member and the bottom member. The inner frame has a geometry smaller than the outer frame, wherein the inner frame is located within the outer frame and connected to the outer frame via one or more connecting arms, wherein the length of the connecting arms determines the vertical position of the inner frame within the outer frame. The planar light emitter is mounted to the inner frame, wherein the planar light emitter includes a thermally conductive plate and a plurality of light-emitting diodes (LEDs) mounted on a first surface of the thermally conductive plate, wherein the plurality of LEDs are located in a two-dimensional plane that is approximately parallel with the top member and the bottom member.

The details of one or more examples are set forth in the accompanying drawings and the description below. Other features, objects, and advantages will be apparent from the description and drawings, and from the claims.

### BRIEF DESCRIPTION OF THE DRAWINGS

The accompanying drawings illustrate non-limiting example embodiments of the invention.

FIG. 1 illustrates a schematic view of an outer frame assembly, according to one or more embodiments of this disclosure.

FIG. 2 illustrates a schematic view of an inner frame assembly, according to one or more embodiments of this disclosure.

FIG. 3 illustrates a top view of a planar light emitter, according to one or more embodiments of this disclosure.

FIG. 4 illustrates a schematic of a luminaire assembly, according to one or more embodiments of this disclosure.

FIG. 4a illustrates a side view of a luminaire assembly, according to one or more embodiments of this disclosure.

FIG. 4b illustrates a side view of a luminaire assembly, according to one or more embodiments of this disclosure.

FIG. 5 illustrates a perspective view of a flexible covering, according to one or more embodiments of this disclosure.

FIG. 5a illustrates a perspective view of a pendant assembly, according to one or more embodiments of this disclosure.

FIG. 5b illustrates a perspective view of a pendant assembly, according to one or more embodiments of this disclosure.

FIG. 6 illustrates an optics schematic, according to one or more embodiments of this disclosure.

FIG. 7 illustrates a schematic view of an electric power assembly, according to one or more embodiments of this disclosure.

### DETAILED DESCRIPTION

The present invention is described with reference to the attached figures, wherein like reference numerals are used throughout the figures to designate similar or equivalent elements. The figures are not drawn to scale and they are provided merely to illustrate the invention. Several aspects of the invention are described below with reference to example applications for illustration. It should be understood that numerous specific details, relationships, and methods are set forth to provide an understanding of the invention. One skilled in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present disclosure provides a pendant luminaire lighting device with an adjustable light source that produces a consistent volume of evenly dispersed omnidirectional light from a planar, directional light source installed within a three-dimensional frame covered by a light-diffusing, semitransparent, decorative fabric and a diffuser. Given its optical performance, the device is ideally suited for both task and ambient lighting applications.

Many embodiments are realized through several aspects including one or more of the design of a planar light emitter having a proprietary coating which uses light emitting diodes (LEDs) as a light source while simultaneously functioning as a light reflector; the relative positioning of the LED chips on the face of the emitter given their associated viewing angle and the vertical positioning of the emitter relative to the overall height and shape of the shade together achieving the desired optics; the sizing of the emitter relative to the size of the top opening of the shade and the adjacent inside walls of the shade; the material used for the shade frame covering; and a bottom or top diffuser, its size and its material properties.

The optical performance of the invention for task lighting is achieved by positioning the horizontally mounted light emitter either higher or lower within the confines of the shade interior. The final vertical positioning of the emitter impacts the light reflected along the inner side walls of the shade as well as from the bottom diffuser. The optical performance of the invention for ambient lighting is achieved by light emitted through the sidewall of the shade, through the top of the assembly, as well as through the diffuser. In some embodiments, each of the various design elements of the invention must be followed in order to achieve desired results.

In general, the embodiments can comprise six main elements: an outer frame, an adjustable inner frame, a planar light emitter, a diffuser, a frame covering, and a controller.

The outer frame element establishes the geometric shape of the pendant. The outer frame takes one of many shapes, including round circular, conical, rectangular, or square. It can be constructed from a rigid material such as steel or a composite material to reduce overall luminaire weight. Assembly of the frame components can be achieved using methods associated with the material (e.g. welding for steel).

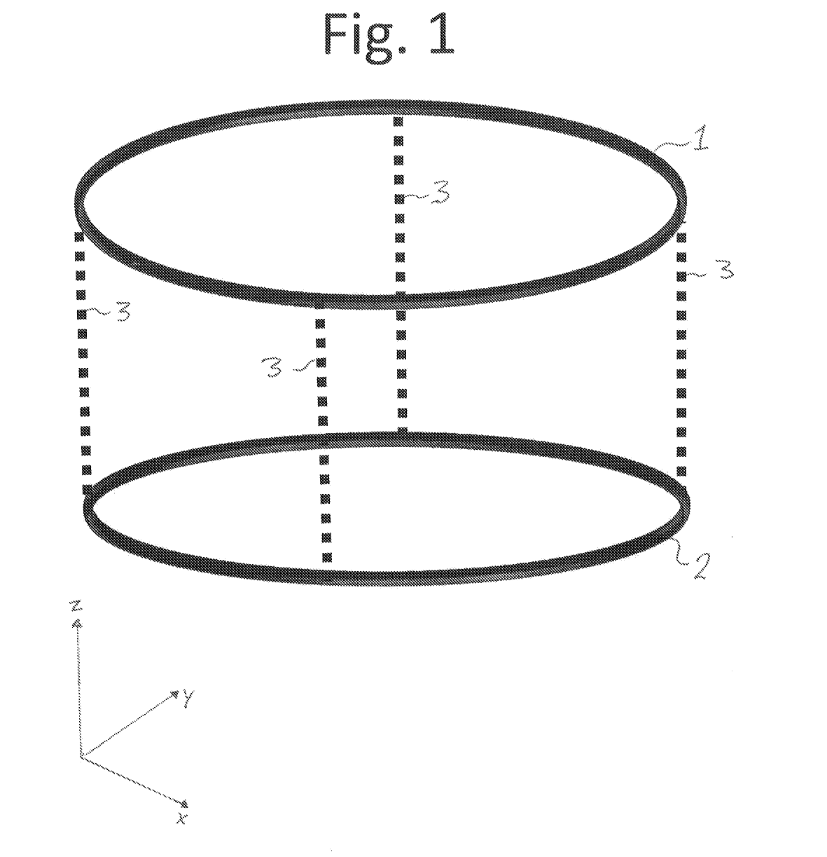

FIG. 1 shows an outer frame assembly that is comprised of a top member (1) and bottom member (2) that may have the same or different geometry. Geometry can include shape and/or diameter. Top member (1) is connected to bottom member (2) with one or more vertical members (3). Vertical members (3) may be distributed equidistantly around the circumference of top member (1) and bottom member (2), or may be a unitary member that defines an outer geometry. As described in more detail below, a frame covering (not shown in FIG. 1) may be placed around the vertical members (3) to define a side surface of the pendant. Collectively these members form the three-dimensional external shape for the pendant. For example, in the embodiment shown in FIG. 1, top member (1) and bottom member (2) have a circular geometry that results in a cylindrical three-dimensional external shape. Other external shapes may be utilized by varying one or more of the top member (1), bottom member (2), and location of vertical members (3).

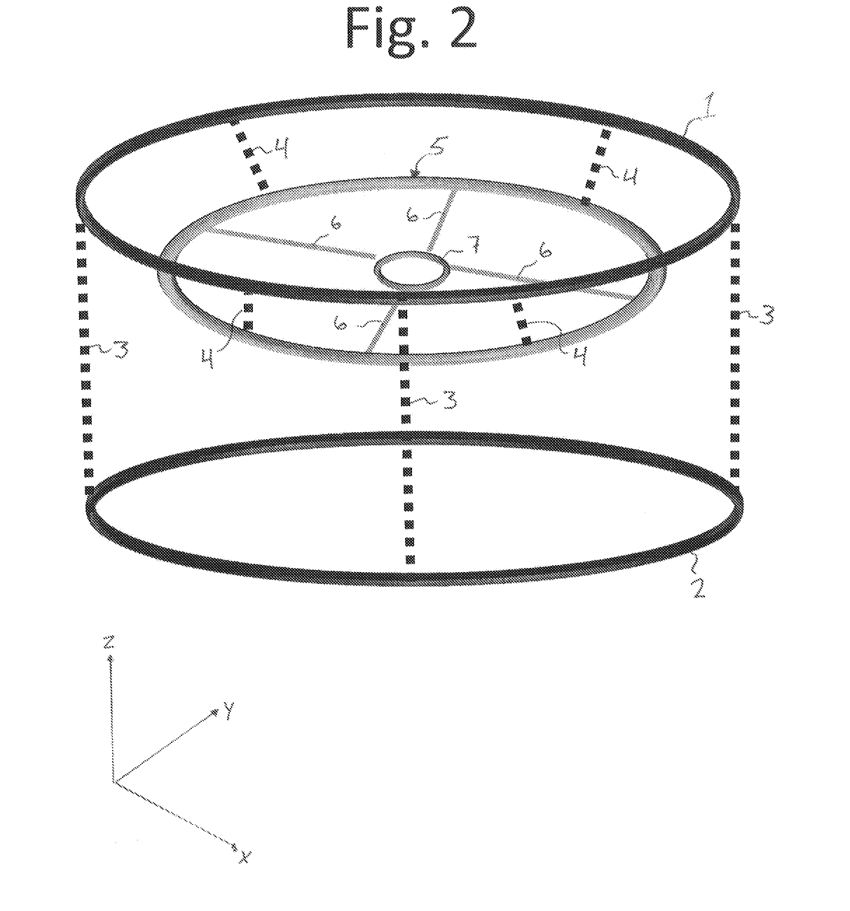

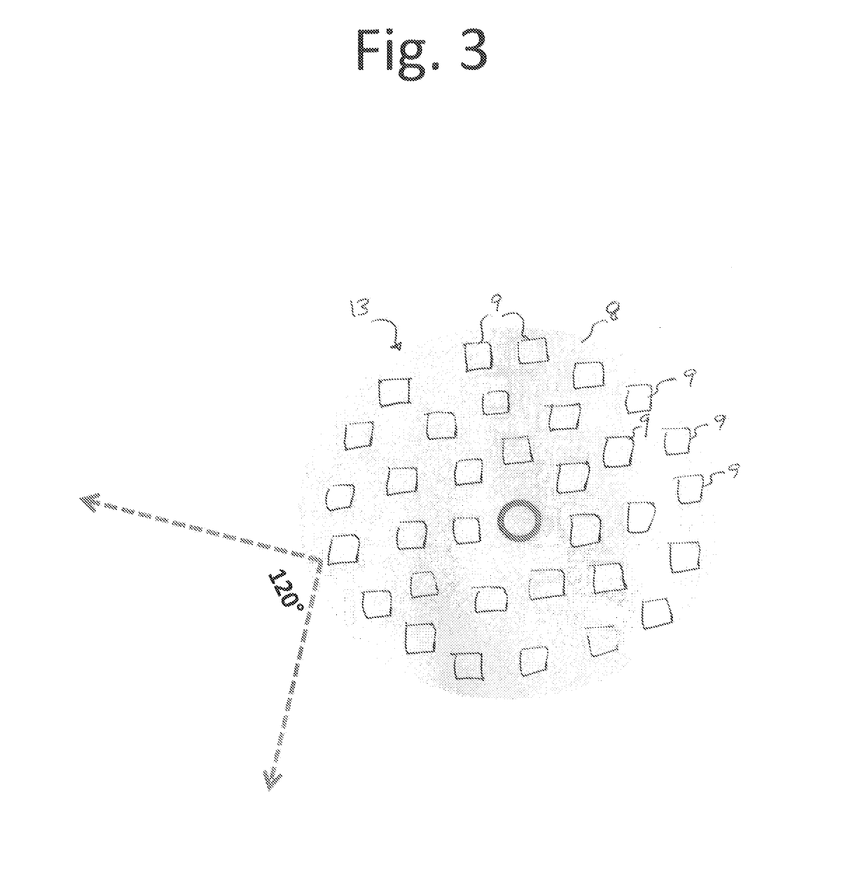

FIG. 2 shows inner frame assembly staring with the outer frame assembly and adding an adjustable inner frame (5). The diameter d₂ of inner frame (5) is smaller than the diameter d₁ of top member (1) such that the smaller fits inside the larger. Inner frame (5) is offset vertically from the horizontal plane formed by top member (1) (i.e., top of inner frame (5) is lower than top member (1)). Inner frame (5) is connected to top member (1) using at least two connecting arms (4), the length and positioning of which are determined such that the horizontal plane formed by top member (1) and inner frame (5) are parallel. At least two reinforcing members (6) are connected to the inside of inner frame (5) at one end and to a round washer (7) at the other end and are positioned parallel at the center of the plane created by connecting arms (4). Reinforcing member (6) and round washer (7) comprise what is commonly referred to as a lampshade “spider and washer” fitter configuration. Once secured, inner frame (5) serves to reinforce the rigidity of the pendant to prevent warping that might otherwise move the positioning of planar light emitter (shown in FIG. 3) as well as serving as a platform onto which assembly plate (28) is secured.

In one embodiment, the length of connecting arms (4) is determined at the time of manufacture based on the desired characteristics of the luminaire. In other embodiments, the length of the connecting arms (4) may be adjustable to allow the vertical location of inner frame (5) to be modified. For example, in one embodiment the connecting arms (4) may be telescoping to allow the length of the arms to be modified. As discussed in more detail below, adjusting the location of inner frame (5) relative to top member (1) (i.e., along the z-axis) modifies the optical characteristics of the luminaire. For example, lowering the inner frame (5) along the z-axis may result in less light escaping through the sides of the luminaire, and more light being directed through the bottom of the luminaire.

FIG. 3 shows planar light emitter (13) in a circle configuration. Other light emitters can be substituted in various shapes such as triangles, rectangles, and squares to match the shape of top member (1) and bottom member (2). Planar light emitter (13) is comprised of a plate (8) having a plurality of light-emitting diodes (LEDs) (9)—not all of which are labeled—attached to the surface of the plate (8). Light is generated from planar light emitter (13) by energizing the collection of LED (9) which have been affixed onto plate (8) being interconnected to one another by the electronic circuitry.

Planar light emitter (13) is novel in its construction such that it can operate with both constant voltage and constant current power configurations and evenly distribute light. This novel feature enables planar light emitter (13) to operate with the traditional constant voltage power sources, and the new more efficient constant current power sources. In one embodiment, plate (8) is constructed of a thermally conductive material (e.g., copper) capable of dissipating heat generated by the LEDs. In another embodiment, plate (8) is comprised of a two or more plates adhered together, each having a plurality of LEDs positioned to generate light in different directions (i.e., positive and negative z direction). The plates may be constructed of the same or dissimilar materials (e.g., copper, aluminum clad, copper clad, etc.), but once again should be thermally conductive in order to dissipate heat generated by the plurality of LEDs. The two plates are adhered using an insulated thermally conductive adhesive that can withstand operating temperatures without losing its adhesion properties. Operating temperatures can refer to ambient temperatures, or temperatures achieved during device operation. In some embodiments, operating temperatures can meet or exceed 105 degree Celsius. In some configurations of planar light emitter (13) design the final circuit assembly is secured and protected by a thermally conductive and reflective protective epoxy (10) such that only the light emitting surface of LED (9) are open (masked off) with the remaining electronic assembly potted into the reflective epoxy. In addition to contributing to the optics of the invention, this design also enables outdoor operation and facilitates cleaning when needed.

In the embodiment shown in FIG. 3, the plurality of LEDs (9) are positioned on plate (8) such that the light emitted by one overlaps the light emitted by its neighbor, which produces an evenly distributed light output. Various sized small to medium LEDs (9) are used in the construction to improve efficacy, thermal management, and to provide built-in redundancy. Planar light emitter (13) uses a collection of series and parallel circuits affixed to plate (8) to which the LEDs (9) are connected. This design feature enables continuous light emission in the event of one or more LED (9) failure. In one embodiment, the LEDs (9) are placed onto plate (8) with a minimum distance of 2 mm from each other, which optimizes density without incurring thermal runaway conditions.

As a result of these design attributes, planar light emitter (13) will produce an evenly dispersed light, offer continuous light emission upon individual LED chip failure, and lower the cost of the pendant by eliminating the need for tight color binning of LED (9) chips and costly thermal management materials.

The quantity of LEDs (9) installed onto planar light emitter (13) is determined based on the required total light output for the pendant and the individual performance of each LED (9). The selection of the LEDs (9) to be used to construct planar light emitter (13) is determined based on the required light output (lumens), color (kelvin temperature) or colors (white, RGB adjustable) and chip viewing angle.

Positioning of the plurality of LEDs (9) on plate (8) may be modified based on the particular application and desired optical performance. Desired optical performance may include the amount of light allowed to be dispersed vertically out of the top of the pendant and/or out of the bottom of the pendant. In addition, positioning of the plurality of LEDs may depend on the geometric relationship of planar light emitter 13 to other features of the pendant light (e.g., outer frame diameter, diffuser panel diameter, viewing angle of the LEDs, etc.)For example, in one embodiment the number of LEDs and position of the LEDs is determined based on the diameter of plate (8) compared to top member (1), the vertical position of the planar light emitter (13) between the top member (1) and the bottom member (2), and the viewing angle (11) of LED (9) which can be 120 degrees as shown.

In addition, the position and plurality of LEDs (9) are selected to ensure heat generated by the LEDs does not result in overheating of the LEDs (i.e., thermal runaway). This is achieved through the heating conducting properties of the plate (8) (e.g., aluminum-clad) which draws and disperses heat produced by LED (9). Additionally, the spacing of LEDs (9) on plate (8) is calculated to prevent thermal runaway where the heat generated by one LED (9) becomes the ambient heat of each adjacent LED (9). In one embodiment, LEDs (9) installed along the edge of plate (8) casts light in a 120° viewing angle (11) pattern which then reflects off the covering (shown below) to produce an evenly dispersed light pattern along the vertical length of the pendant. This approach results in the elimination of undesirable bright (hot) and dark spots on the outside of covering (16). In other embodiments, other orientations of LEDs may be selected depending on the application.

FIG. 3 also shows that holes, such as the center hole (12), are drilled in plate (8) and are used to secure planar light emitter (13) to inner frame (5). In addition, in some embodiments an epoxy protective coating is deposited onto the front of plate (8). The epoxy layer covers and protects the electronic circuitry that has been adhered to plate (8), making it safe from accidental electrical exposure and resistant dust and moisture. In one embodiment, epoxy (10) is white in color which provides additional light reflectivity, increasing the luminous efficacy of planar light emitter (13). In addition to planar light emitter (13) depicted here, other lighting technologies such as organic light emitting diode (OLED) can be installed onto plate (8) to generate the required light emission for the luminaire.

In one embodiment, the diameter of planar light emitter (13) is less than the diameter of the top member (1) but larger than inner frame (5) such that when mounted and attached to inner frame (5) planar light emitter (13) does not fully enclose the area of the frame formed by top member (1). A benefit of this configuration is the space between planar light emitter (13) and top member (1) allows reflected light to pass upward, to illuminate the area on covering (16) between the horizontal plane formed by inner frame (5) and the horizontal plane formed by top member (1). The spacing also allows light to be emitted upward through the top of the luminaire to illuminate the ceiling and/or adjacent wall areas. These features of these embodiments are important to achieve the desired aesthetic value of the luminaire to designers, among others.

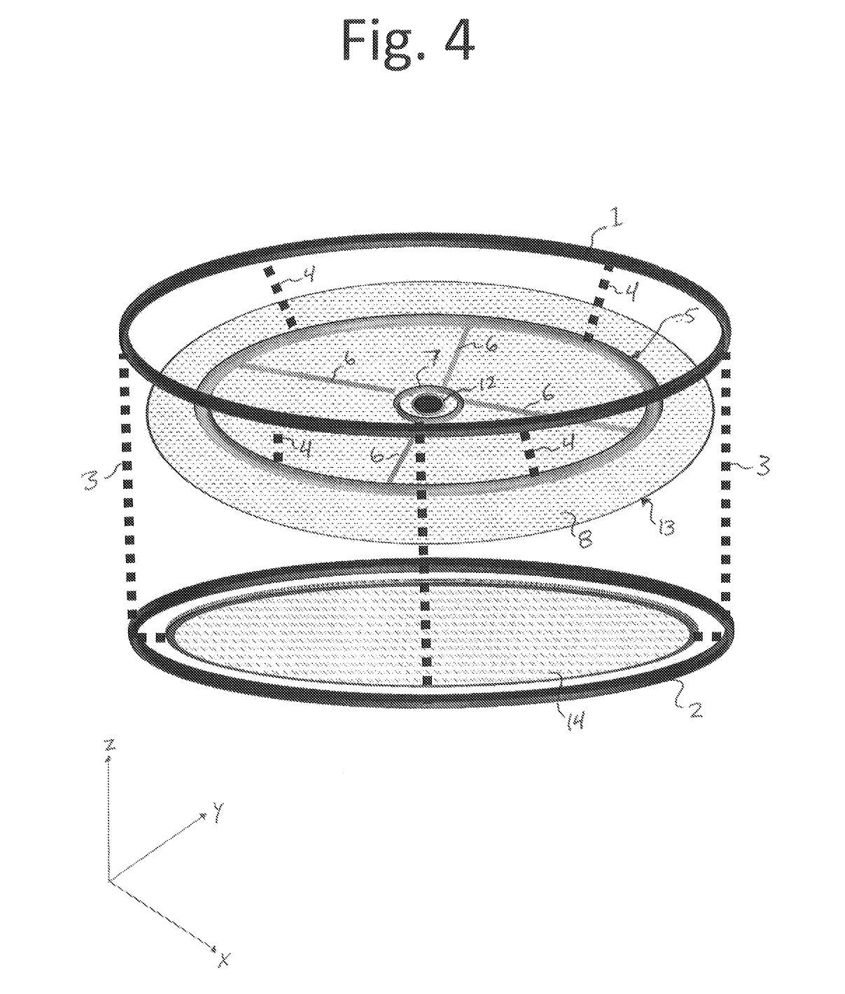

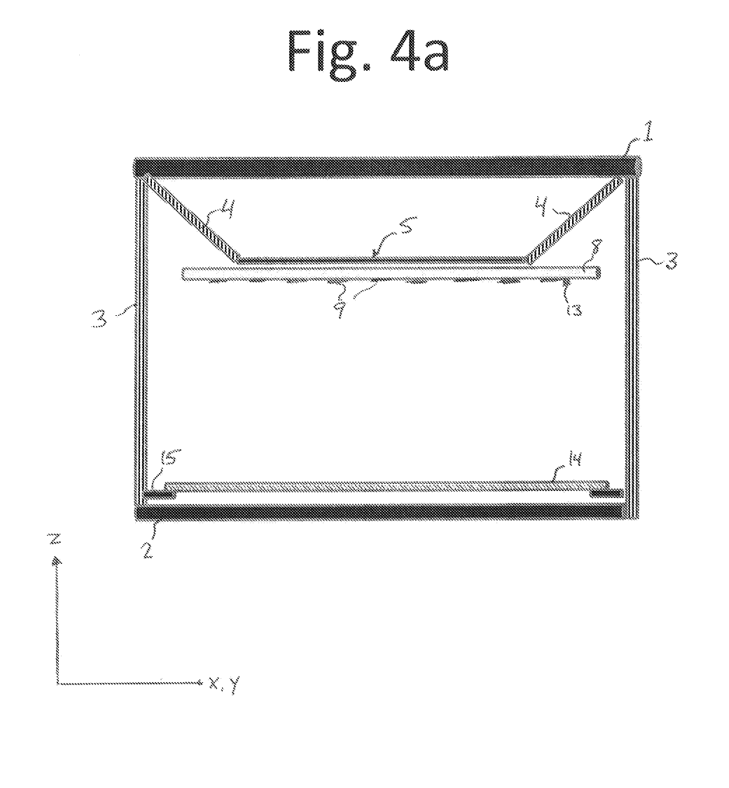

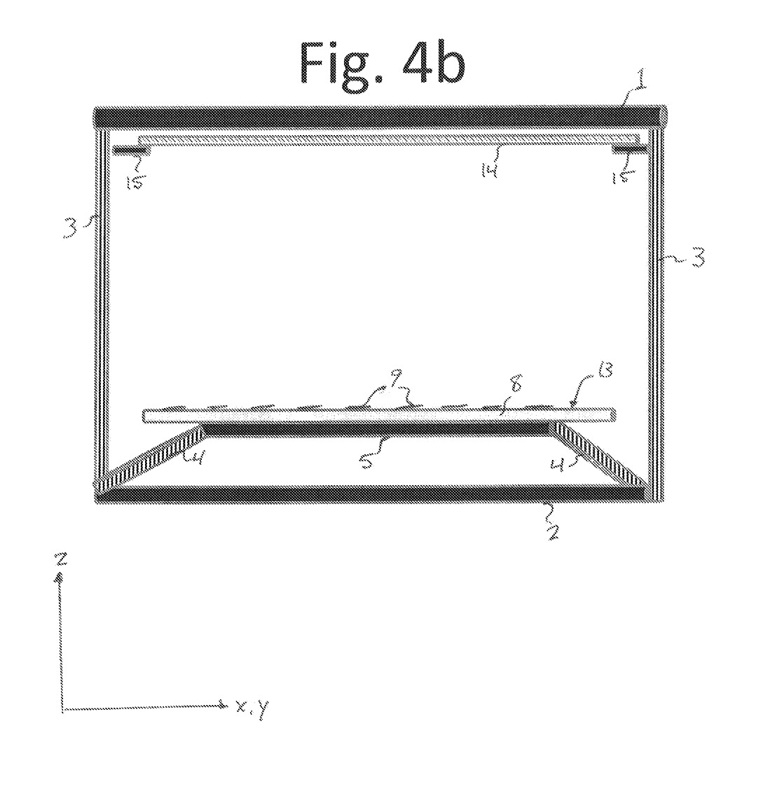

FIG. 4 shows the luminaire assembly with planar light emitter (13) installed onto inner frame (5) via center hole (12) and round washer (7). In addition, FIG. 4 illustrates installation of a diffuser panel (14), which is affixed to bottom member (2). In this embodiment, planar light emitter (13) is oriented such that LEDs (9) face downward in the negative z-axis direction. In another embodiment, a second planar light emitter (13) may be installed and attached to inner frame (5) with LED (9) facing upward in the positive z-axis direction. In these instances, such a second planar light emitter (13) would serve to increase overall light emission of the luminaire by adding LED (9) onto another surface due to exhausting the surface area of plate (8) of the primary downward-facing planar light emitter (13). In this arrangement, it may be beneficial to secure inner frame (5) at a vertical position approximately between top member (1) and bottom member (2). Once secured to inner frame (5), planar light emitter (13) provides additional structural integrity to the pendant frame, preventing tilting or warping of the frame components which will result is misdirection of the light emitted by planar light emitter (13). In the embodiment shown in FIG. 4, light generated by the LEDs mounted on planar light emitter (13) are directed in the negative z direction toward diffuser panel (14), with some of the light being directed to the side covering (not shown in this view). Diffuser panel (14) is selected to allow a desired amount of light through the bottom of the pendant while reflecting a portion of the incident light back toward the top of the pendant. The amount of light transmitted through diffuser panel (14) versus reflected back toward the top of the pendant is based on the particular materials selected.

FIGS. 4a and 4b are cross-sectional views that illustrate various positions of inner frame (5)—and therefore various positions of planar light emitter (13)—along the z-axis. In FIG. 4a, inner frame (5) is attached to top member (1) and is positioned closer to top member (1) than bottom member (2). LEDs are positioned on the bottom surface of planar light emitter (13) such that light generated in this plane is in the negative z direction (i.e., towards the bottom of the pendant). In another construction of the invention depicted in FIG. 4b, inner frame (5) may be attached to bottom member (2) using angled member (4). In this construction, when inner frame (5) is offset from bottom member (2), planar light emitter (13) is attached to inner frame (5) through center hole (12) with LED (9) facing in an upward direction.

Also shown in FIGS. 4, 4a and 4b is diffuser panel (14). In one embodiment, diffuser panel (14) is constructed from acrylic or a similar material for providing the desired transmission/reflection characteristics depending on the application. In the embodiment shown in FIGS. 4 and 4a, diffuser panel (14) sits on top of tab (15) which has been attached to bottom member (2). In FIG. 4b, diffuser panel (14) is affixed to tabs (15) attached to top member (1). Diffuser panel (14) may have a smooth or irregular surface, depending on the desired reflectivity of light within the shade. The diameter of diffuser panel (14) is smaller than the diameter of bottom member (2) and sits atop the tabs (15) to facilitate ease of installation and removal for maintenance. Diffuser panel (14) also performs an important function in that it reflects upward some of the light from planar light emitter (13) and allows some light to pass downward while ensuring that unshielded LED (9) are not exposed from beneath the luminaire once it has been mounted to the ceiling. A profile of this assembly is shown in FIG. 4a.

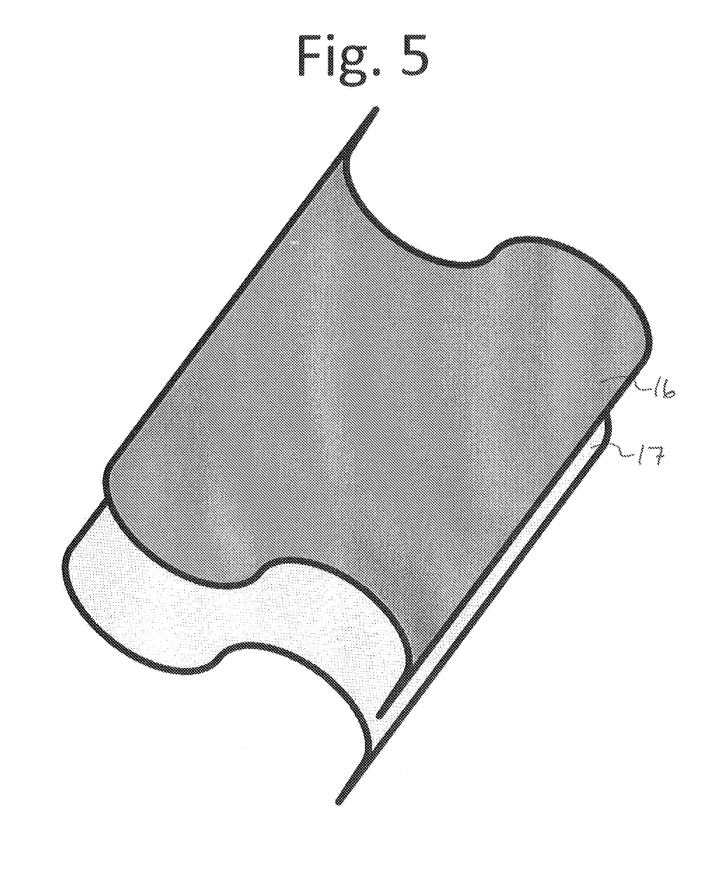

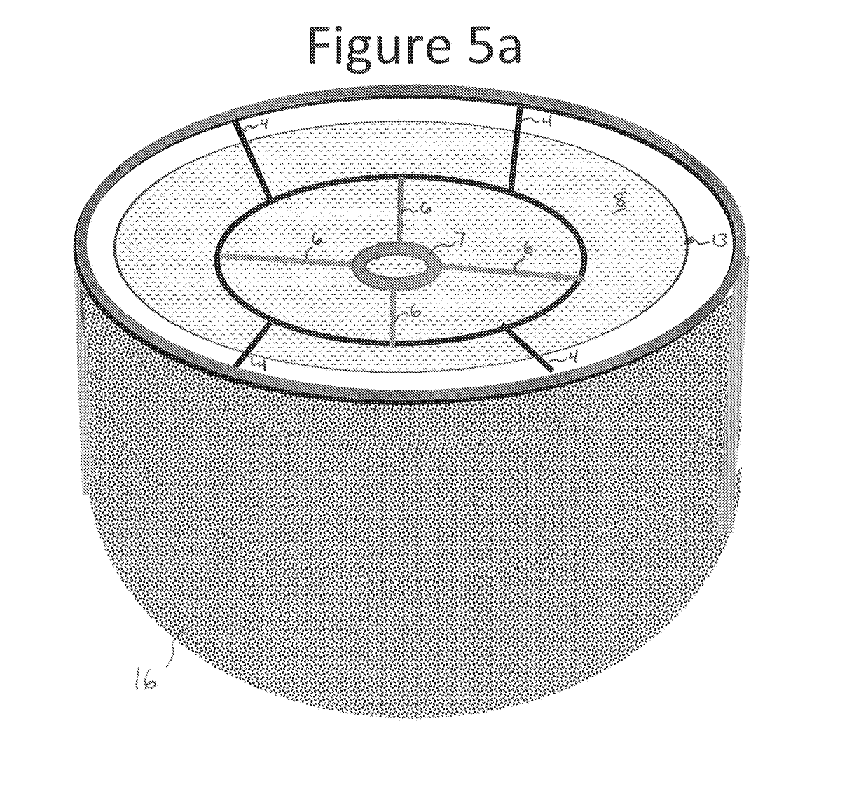

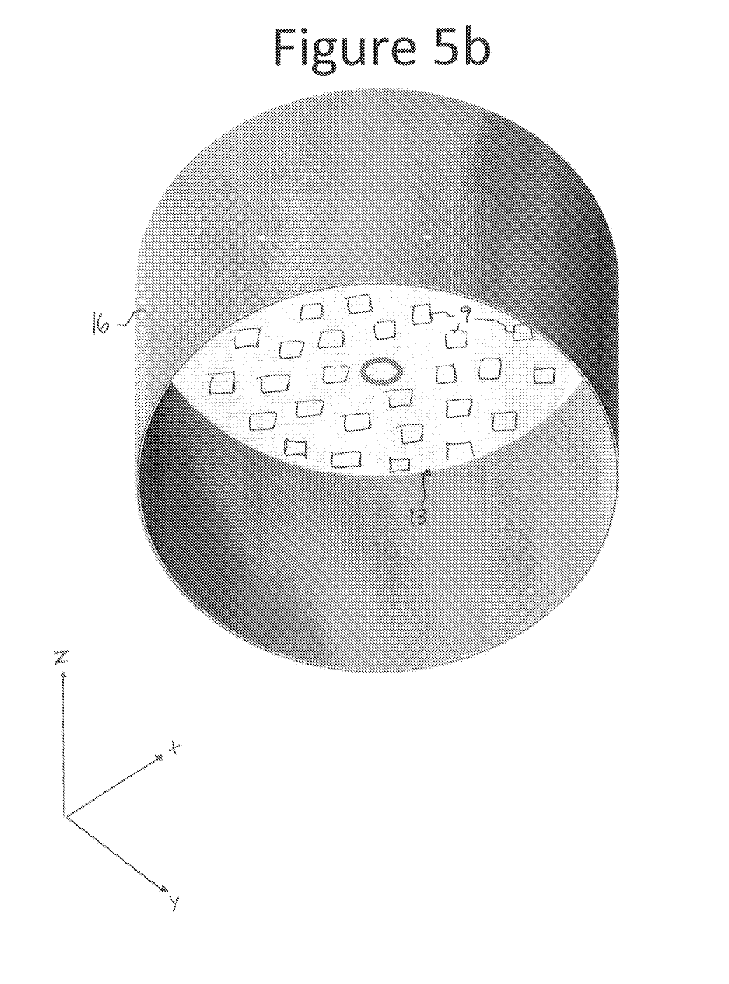

FIG. 5 shows the flexible covering (16) used to enclose the pendant outer frame assembly. In one embodiment, covering (16) is made from a fabric which has semitransparent optical properties. If covering (16) is the only covering used, vertical members (3) may be required to connect top member (1) and bottom member (2) to form the desired shape of the outer frame assembly. In the embodiment shown in FIG. 5, however, a second material, such as flexible plastic sheet (17) made from polystyrene or a similar material may be laminated together with covering (16), forming what is often referred to as a “hardback lampshade liner”. The joined material provides sufficient stiffness such that when wrapped around the outer frame assembly, the shade will form and retain the desired shape while preventing drooping or warping. In one embodiment, plastic sheet (17) may be white in color to maximize its light reflecting properties. The surface of plastic sheet (17) may be smooth or irregular. An irregular surface may be created by adding texture to the surface with a resulting surface that increases its light reflecting capability.

FIG. 5a shows the pendant assembly with covering (16) wrapped around the outer frame assembly. Covering (16) is adhered to top member (1) using adhesive tape wrapped over top member (1) and the top edge of covering (16). A similar attachment method is used to attach the bottom edge of covering (16) to bottom member (2). FIG. 5b shows the pendant assembly from below without diffuser panel (14) where LED (9) installed on planar light emitter (13) facing downward.

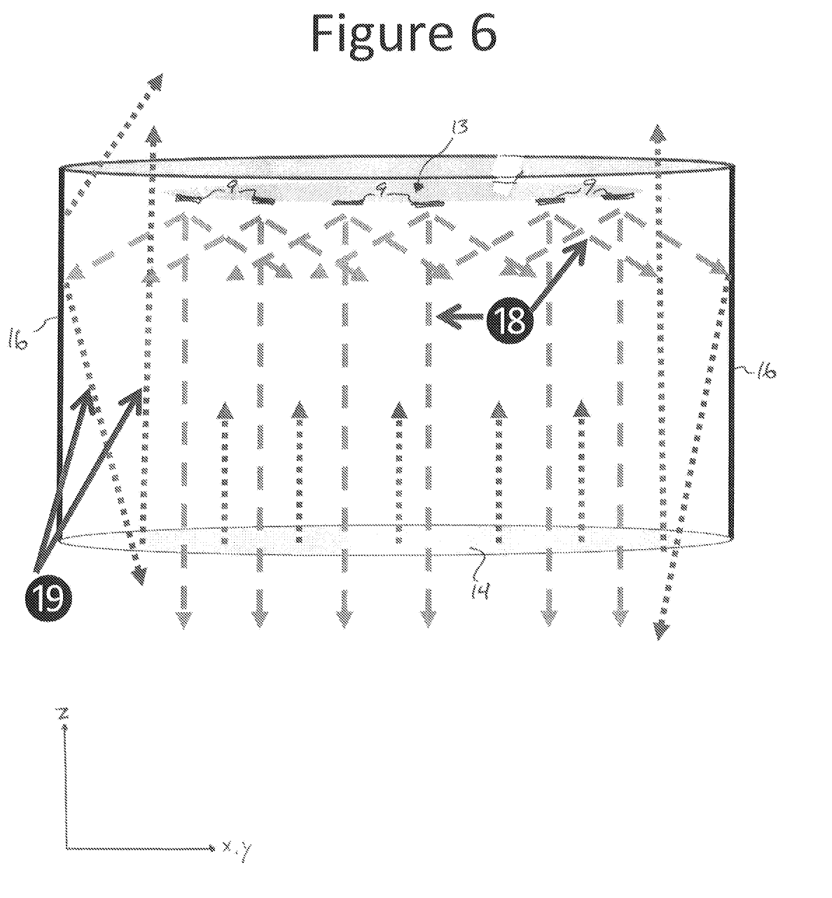

FIG. 6 shows the optics achieved with the completed assembly. Light is generated by each LED (9) installed on planar light emitter (13). Light (18) generated by the LEDs (9) travels in a direction approximately perpendicular to plane defined by planar light emitter (13). In the embodiment shown in FIG. 6, the light (18) is directed in a downward direction. Directional light (18) waves travel in a straight line from the center of LED (9) and across the viewing angle shown in FIG. 6 using a “dashed line” in 120° from the center of LED (9). Reflected light wave (19) is created when directional light (18) reaches either the inside surface of covering (16) or plastic sheet (17) or diffuser panel (14). Reflected light wave (19) is shown in FIG. 6 using a “dotted line”. Since planar light emitter (13) has a smaller diameter than top member (1), reflected light wave (19) can escape from the top of the pendant to provide ambient light.

In the embodiment shown in FIG. 6, planar light emitter (13) is located near the top of the pendant (i.e., inner frame (5) is located close to top member (1)). As a result, a substantial amount of light generated by the LEDs is allowed to contact the sides of the pendant (i.e., covering (16)), where it is either transmitted or reflected back, depending on the materials utilized. Thus, depending on the material selection, this configuration could allow for light to be transmitted through the sides of the pendant, with less light communicated directly below the pendant. In embodiments in which the vertical position of planar light emitter (13) is adjustable, the optical characteristics of the pendant may be modified by lowering the planar light emitter (13) relative to the top member (1). For example, the amount of light allowed to contact the side walls of covering (16) would be reduced, and more light would be communicated to the bottom portion of the pendant. In one embodiment, this could be utilized to provide more high intensity light directly between the pendant. In this way, the optical characteristics of the light may be modified simply by modifying the vertical position of the planar light emitter (13).

Embodiments herein can include an external control device that will provide power conversion as well as power and light output management (the “controller”). The controller can convert standard AC line voltage to the DC current required to power LED (9) on planar light emitter (13). An external control device can also enable the use of a remote “dimmer” which, when enabled, will allow user-control over device light output level.

The controller and related electric electrical interconnections can be located within the pendant or can be remotely located (e.g. in a commercial suspended ceiling). The controller will enable lighting functions such as dimming via wiring, RF or Wi-Fi remote control. It will also enable integrating the pendant into a building's low-power device control network.

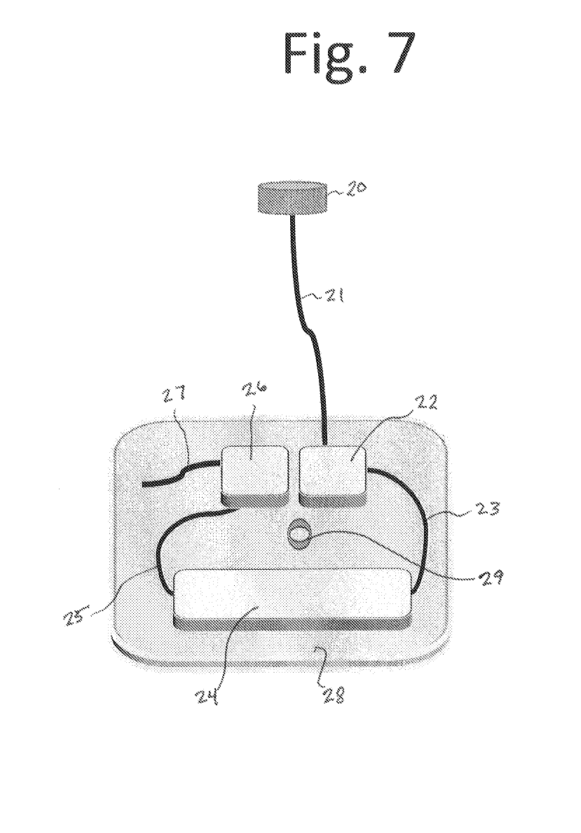

FIG. 7 shows the electric power assembly for the present invention. In this manifestation of the invention, power for planar light emitter (13) is obtained from controller (24). AC power is accessed via junction box (20) installed in the ceiling. Line power cable (21) exits junction box (20) and enters line power junction box (22) and is connected to controller (24) which obtains AC power from line power input cable (23).

Planar light emitter (13) obtains its required DC power from low power output cable (25) which exits controller (24) enters low power junction box (26) where it is connected to planar light emitter (13) input power cable (27). Line power junction box (22), controller (24) and low power junction box (26) are mounted to assembly plate (28) through hole (29) which is used to secure assembly plate (28) to inner frame (5).

In this way, the present invention provides a lighting pendant that utilizes a planar light emitter comprised of a plurality of LEDs mounted in a particular plane. The vertical position of the planar light emitter may be selected and/or modified to vary the optical characteristics of the pendant. A benefit of utilizing a planar light emitter configured with a plurality of LEDs positioned along the same plane (i.e., horizontal plane) is that the pendant does not suffer from the traditional hot/dark spots associated with bulbs (either incandescent or LED). In addition, the present invention allows the optical characteristics of the pendant to be modified by changing the vertical position of the planar light emitter, allowing more or less light to exit via the bottom of the pendant versus the side and/or top of the pendant.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A lighting device, comprising:
an outer frame having a top member, a bottom member, and one or more vertical members connected between the top member and the bottom member;
an inner frame having a geometry smaller than the outer frame, wherein the inner frame is located within the outer frame and connected to the outer frame via one or more connecting arms, wherein the length of the connecting arms determines the vertical position of the inner frame within the outer frame; and
a planar light emitter mounted to the inner frame, wherein the planar light emitter includes a thermally conductive plate and a plurality of light-emitting diodes (LEDs) mounted on a first surface of the thermally conductive plate, wherein the plurality of LEDs are located in a two-dimensional plane that is approximately parallel with the top member and the bottom member.

2. The lighting device of claim 1, wherein the one or more connecting arms are adjustable in length.

3. The lighting device of claim 1, wherein the top member and the bottom member have a shared geometric shape.

4. The lighting device of claim 1, wherein the inner frame is connected to the top member of the outer frame via the one or more connecting arms.

5. The lighting device of claim 1, wherein the planar light emitter includes a plurality of LEDs mounted on a second side of the thermally conductive plate.

6. The lighting device of claim 5, wherein the thermally conductive plate includes a first thermally conductive plate having a first plurality of LEDs mounted on a first side and a second conductive plate having a second plurality of LEDs mounted on a second side, wherein the first and second thermally conductive plates are adhered to one another to allow light to be provided in the vertical plane in both directions from the thermally conductive plate.

7. The lighting device of claim 1, wherein a diameter of the planar light emitter is less than a diameter of the outer frame.

8. The lighting device of claim 1, further including a diffuser mounted to the bottom member.

9. The lighting device of claim 8, wherein a diameter of the diffuser is approximately equal to the diameter of the bottom member.

10. The lighting device of claim 8, further including a second diffuser connected to the top member.

11. The lighting device of claim 1, wherein the lighting device further includes a frame covering affixed to the top member and the bottom member that defines a sider surface of the lighting device.

12. The lighting device of claim 1, wherein the amount of light that exits the lighting device via the frame covering depends, in part, on the vertical position of the planar light emitter.

13. The lighting device of clam 12, wherein the amount of light that exits the lighting device via the frame covering depends, in part, on the reflectivity of a material selected for the frame covering.

14. The lighting device of claim 13, wherein the frame covering further includes a plastic sheet to increase the reflectivity of the frame covering.

15. A pendant lighting device, comprising:
a cylindrical outer frame having a top member, a bottom member, and one or more vertical members connected between the top member and the bottom member;
an inner frame having a geometry smaller than the outer frame, wherein the inner frame is located within the outer frame and connected to the outer frame via one or more connecting arms, wherein the length of the connecting arms determines the vertical position of the inner frame within the outer frame;
a planar light emitter mounted to the inner frame, wherein the planar light emitter includes a thermally conductive plate and a plurality of light-emitting diodes (LEDs) mounted on a first surface of the thermally conductive plate, wherein the plurality of LEDs are located in a two-dimensional plane that is approximately parallel with the top member and the bottom member;
a diffuser panel connected to the bottom member that is similar in size and geometry with the bottom member; and
a frame covering attached to the top member and the bottom member that defines an outer side surface of the pendant lighting device.

16. The pendant lighting device of claim 15, wherein the length of the connecting arms is adjustable to allow the vertical position of the inner frame and planar light emitter to be modified relative to the top member.

17. The lighting device of claim 16, wherein the amount of light that exits the lighting device via the frame covering depends, in part, on the vertical position of the planar light emitter.

18. The lighting device of claim 15, further including a second diffuser connected to the top member.
